(19) United States
(12) Patent Application Publication
(10) Pub. No.: US 2015/0324727 A1
(43) Pub. Date: Nov. 12, 2015

(54) STAFF WORK ASSIGNMENT AND ALLOCATION

(71) Applicant: Avaya, Inc., Basking Ridge, NJ (US)

(72) Inventors: George Erhart, Loveland, CO (US); Valentine C. Matula, Granville, OH (US); David Skiba, Golden, CO (US)

(73) Assignee: Avaya, Inc., Basking Ridge, NJ (US)

(21) Appl. No.: 14/273,195

(22) Filed: May 8, 2014

(51) Int. Cl. G06Q 10/06

(52) U.S. Cl. CPC G06Q 10/063114

(57) ABSTRACT

Correctly staffing retail settings is a challenge. While calendar based staffing decisions, such as increasing staffing for a holiday sale, may provide high-level staffing recommendations. The activities of customers may be monitored to provide a more granular staffing allocation. Customers who, for example, spend a certain duration of time within one portion of the retail setting may be determined to indicate a need for assistance and a staff member of the retail setting allocated to assist the customer or customers within an area with a spike in customer activity. Similarly, customers who indicate a desire to purchase an item requiring certain staff skills (e.g., verify customer identity, complete legal documents, lift heavy items, etc.) may be detected and an appropriate staff member allocated. As a result, the customer may receive assistance from staff members having the required skills to complete their purchase.

### FIELD OF THE DISCLOSURE

The present disclosure is generally directed toward allocating staff to service customers in a retail setting.

### BACKGROUND

Retail establishments today often use a combination of automated and live services to efficiently serve their customers. In current systems, a manager has to collect information from a contact center floor using a customer management system (“CMS”) or other management system, collect information from a kiosk and other automated services, and even more information from a store floor. Deciding how many people need to be manning each station and/or taking escalations in all parts of the business is not an easy tasks.

Statistical analysis and reporting in contact centers are relatively well-defined. For instance, there are a great number of Key Performance Indicators (“KPIs”) that are used to measure site and employee performance. There is also operational statistics and analytics. For instance, an enterprise generally knows how well it is performing based on sales, average revenue per transaction, labor costs, etc.

Retail establishments commonly use work force optimization (“WFO”), a method that helps businesses balance efficiency and effectiveness by using the contact center as a strategic resource. Analytics-driven WFO allows organizations to capture, analyze, and act on information to improve performance, interactions, and processes. However, even with such sophisticated techniques, problems remain.

### SUMMARY

It is with respect to the above issues and other problems that the embodiments presented herein were contemplated. Described with respect to certain embodiments herein, is the ability for a retail establishment to combine locally gathered statistics with operational statistics to gain a better understanding of how well a business is operating in real-time and over an extended period of time.

Despite operational efficiencies that exist today, certain areas are not covered and, therefore, not rolled-up into WFO to provide a real-time, accurate automatic assessment and prediction model. Disclosed with respect to certain embodiments, are systems and methods operable to roll-up local, automatic, and remote services into operational information to provide automatic immediate staffing estimates and long-term projections, referred to as preferred staffing profiles.

To provide a full and accurate automatic model and reporting system that can be used for staffing, the certain aspects disclosed are operable to know the length of queues, number of customers served, number of customer abandons, the average customer service time required, as well as local (i.e., in-store) clerk statistics combined with kiosk statistics and contact center statistics for calculating total staffing required. The staffing is done with analytics to provide accuracy, incorporating staffing of clerks, central staff, and management.

Certain processes disclosed monitor key aspects that impact the level of service customers receive. By using all the media and information from a location, a profile of the normalized metric levels is generated with optional manual intervention to accommodate key outlier situations. During monitoring, data are recorded and as certain thresholds are achieved, notifications may go out to one or more employees. Reports generated can assist future staffing and operational budget needs.

As a benefit, certain conditions may be detected and managed accordingly:

1. Temporarily too busy detected; redistribution of existing staff (i.e., long queue at register 4).

2. Shift or near-term busy detected; notification to managers for shift management/adjustment (i.e., traffic is higher than normal today).

3. Holiday or special occasion busy detected; year over year comparisons, staffing profile suggestions.

In one embodiment, video cameras and badges equipped with RFID (and/or other monitoring/observing tools) are used to monitor and report on line waiting time, abandons, successful sales, etc., and are fed back into overall WFO statistics for the company. One benefit of such an embodiment is to provide the appropriate aggregation, identification, and distribution of resources in all sectors in real-time.

RFID may additionally be used to accurately predict the customer wait time based on the number of items and the complexity of items to be purchased, where some customers have many items (longer processing time), others have only a single item (shorter processing time), and others may have one or two complex items (medium processing time). The system can utilize volume, location, number of customers and skills of resource/number of resources to accurately predict wait time and provide notification if other and/or additional resources are needed (i.e., alert for more cashiers when more than 3 people in line are purchasing 5 or more items).

Embodiments also include a system with the functionality to coach and/or provide feedback to the resources based on current observations, as well as identify current anomalies and possible solutions. A user interface is provided for the manager to receive alerts, make immediate and near-term adjustments, and to run forecasts and reports.

Once the data is collected, it may be stored in a database or other data repository. The stored and/or live data may be used to generate staffing statistics and predictive needs based on events, times, and the like for one or more local retail outlets. It is anticipated that individual retail outlets may generate and store staffing statistics at a central storage location. These centrally stored statistics may be combined and analyzed for patterns to determine operational statistics associated with staffing levels.

In one embodiment, a method is disclosed, comprising: monitoring, by machine-based detection equipment, a retail setting and one or more customers therein; comparing, by a microprocessor, an activity comprising at least a duration of time spent by the one or more customers within a first portion of the retail setting to a current staff allocation; and based on the comparison step, determining that adjusting the current staff allocation would place the retail setting in a more ideal state, notifying a resource allocation manager to apply a staffing allocation adjustment.

In another embodiment, a system is disclosed, comprising: a first sensor; a microprocessor; and a staffing allocation manager; and wherein the first sensor is operable to monitor a first portion of a retail setting and one or more customers therein; wherein the microprocessor is operable to compare an activity comprising at least a duration of time spent by the one or more customers within the first portion of the retail setting to a current staff allocation; and wherein the processor, based on the comparison step, determining that adjusting the current staff allocation would place the retail setting in a more ideal state, notifying the resource allocation manager to apply a staffing allocation adjustment.

In another embodiment, a non-transitory computer readable medium is disclosed with instructions thereon, that when read by a computer, cause the computer to perform: monitoring, by machine-based detection equipment, a retail setting and one or more customers therein; comparing, by a microprocessor, an activity comprising at least a duration of time spent by the one or more customers within a first portion of the retail setting to a current staff allocation; and based on the comparison step, determining that adjusting the current staff allocation would place the retail setting in a more ideal state, notifying a resource allocation manager to apply a staffing allocation adjustment.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts customers purchasing items in accordance with embodiments of the present disclosure;

FIG. 3 depicts a retail setting in accordance with embodiments of the present disclosure; and

FIG. 4 depicts a process 400 in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedent.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

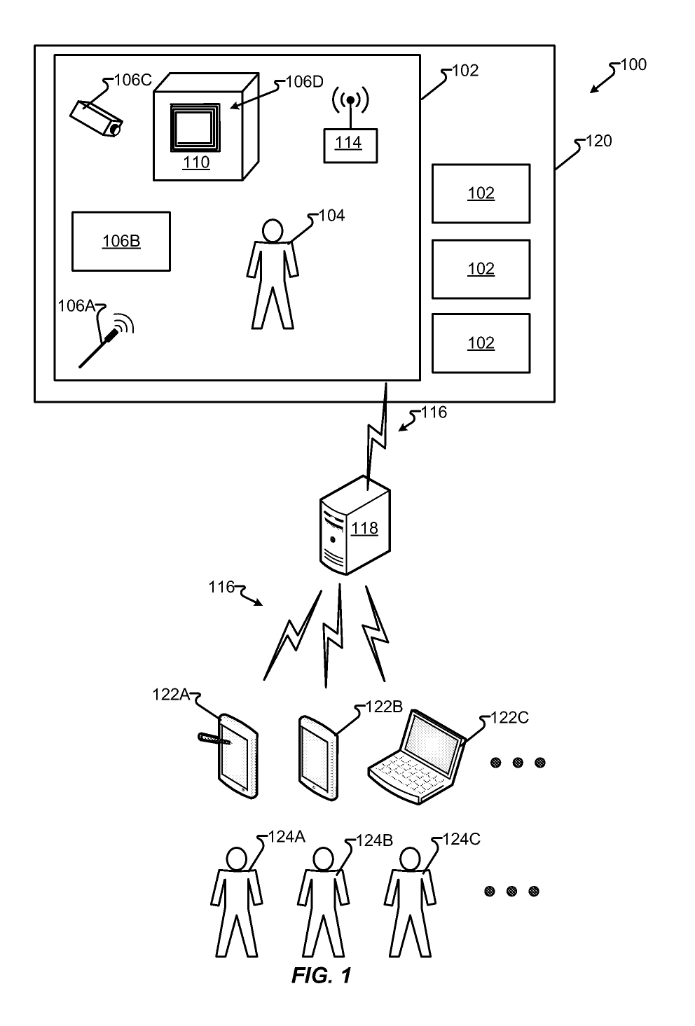

With reference now to FIG. 1, system 100 will be described for allocating staff 124 in accordance with embodiments of the present disclosure. Retail setting 120 contains a number of portions 102. With respect to certain embodiments disclosed herein, the activity of customer 104, which may represent a single individual, two or more individuals shopping as a unit, and/or a plurality of individuals and/or units, is used to provide a more immediate staffing allocation feedback to enable retail setting 120 to operate in a more ideal state as compared to without such staffing allocation. Staffing allocation may initially be set by a WFO program operating on sever 118 and/or another system.

The actions of customer 104 in a particular portion 120 may be used to allocate staff 124 in the same portion 120 or a different portion 120. Portion 102 may be the entirety of a sales floor, a portion of a larger retail setting (e.g., department, section, more autonomous departments, such as a floral shop or pharmacy within a grocery store, etc.), and/or a non-sales floor area accessible by customers (e.g., parking lot, doorway, corridor, and/or other approach/departure/waiting area, etc.). Portion 102 may include an areas not intended for access to customers may also be included, such as may be used to notify security personnel or other personnel of an anomalous situation.

In one embodiment, portion 102 is monitored by at least one device 106. Device 106 is operable to detect the presence of a person, which may identify only that a person is or is not present (e.g., pressure mat 106B), distinguish between the person being customer 104 or staff member(s) 124, (e.g., pressure mat 106B detecting a person, however, WiFi badge (not shown) worn by staff member(s) 124 is detected in the area and, therefore, the person on pressure mat 106B is likely not customer 104), or identify the specific customer 104 (e.g., receiver 114 detects a radio signal from a device (not shown) carried by a specific customer 104.

Devices 106 may include microphone 106A, pressure mat 106B, camera 106C, radio frequency identification (“RFID”) tag 106D, receiver 114, or other sensing device. Devices 106 may themselves, or via other systems, process signals received to identify or better identify customer 104 (e.g., facial recognition software, footstep analysis, speech recognition, etc.). Receiver 114 may be configured to receive signals from RFID tag 106D and/or signals from transmitting devices associated with customers (e.g., cellular, WiFi, Bluetooth, etc. enabled devices). The location of item 110, and customer 104 having selected item 110, may be determined via RFID tag 106D associated with item 110. As a result of devices 106, the location of customer 104 may be determined. Additional technology may be employed, such as image tracking software or other means to identify a specific customer 104 or to at least distinguish between one customer 104 and another customer 104 and they move throughout retail setting 120 and/or one or more of portions 102.

Portion 102 and/or devices 106 therein utilize communication link 116 to connect to processing equipment, such as server 118. Communications link 116 may be one or more of a wired and wireless network, such as Ethernet, Internet, cellular network, fiber optic, WiFi, infrared, and/or other communications technology to enable one or more of devices 122 and/or wired/wireless, cellular/etc. In one embodiment, server 118 determines when the actions of customer 104 have, or will, place one or more portion 102 in a state that is less than ideal.

What is and is not ideal is a matter of design choice as the operation of one portion 102 be different from another portion 102 and/or the events, such as time, holiday, season, or other event may cause the optimum state of a single portion 102 to vary. It should be noted that embodiments described herein may achieve an ideal state for one or more portions 102 and/or retail setting 120, however it will often be the case that only a more ideal state is possible. For example, if an unexpected rush of customers 104 flood the store, twenty additional staff members 124 may be needed to return to an ideal state. However, if only ten staff members 124 are on-site or otherwise eligible to assist the new customers 104, then “more ideal” state would be the adding of at least one staff member 124, as compared to status quo, and an even more ideal state is adding as many as possible. WFO systems may be incorporated to, for example, notify on-call staff members 124 not currently working to report, if the influx of customers 104 is predicted to last longer than an estimated time for on-call staff members 124 to become available.

For example, if portion 102 is an area including custom tailored clothing, the operators of portion 102 may determine that an ideal state is a customer-to-staff ratio of one-to-one, as fitting custom clothing often requires the dedicated services of staff member 124 for a period of time. In contrast, if portion 102 is an area including books or other reading material, the operators may strive to maintain a much lower, and therefore cost effective, ratio of customers to staff to allow customers to browse items at a more leisurely pace and without interruptions, but still be available find assistance if desired. Therefore, the ideal state may be a customer-to-staff ratio of ten-to-one. If server 118 determines that retail setting 120 is not in, or will not be in, an ideal state, server 118 may utilize network 116 to communicate with agent devices 122. Agent devices 122 may include, tablet computer 122A, smartphone 122B, laptop 122C, marquee, audible message generator, tactile message generator, computer display, and/or other device operable to receive messages and present messages to staff members 124. One or more of staff members 124 may be managerial staff, who upon receiving a notification, select other staff members 124 to provide the service that would place portion 102 in a more ideal state.

In one embodiment, customer 104 has placed item 110 into a shopping cart. Item 110, via RFID tag 106D in communication with receiver 114, has communicated with server 118 that it is in motion and indicative of a likely purchase by customer 104. Item 110, along with a number of other items, may indicate a volume of anticipated purchases that exceeds the current capacity of the cashiering staff. Server 118 then determines that the wait time for customers to make their purchases is longer than a threshold amount (e.g., portion 102 is about to enter a less than ideal state). Accordingly, server 118 causes a notification to be sent to allocate additional cashiering staff, such as by signaling device 122A to notify staff member 124A to report to a cashiering station.

In other embodiment, item 110 may be a high-value item requiring purchase approval of a manager, for example staff member 124B. Accordingly, device 124B is signaled to present a notification and cause staff member 124B to report to the checkout area or otherwise anticipate approving the purchase of item 110.

The determination that item 110 is about to be purchased, or otherwise require the activity of a resource, may be determined by direct measurement (e.g., associated RFID tag 106D is in motion, as described above), or indirectly. For example, portion 102 may have twenty individual customers 104. Historical observations may indicate that two of those twenty customers 104 are within portion 102 to purchase, at least, one of item 110. Similarly, historical evidence may show that a certain percentage of customers 104 who select item 110 for purchase, fail to complete the purchase (e.g., abandonment). Accordingly, the prospect of a likely purchase of item 110 may be factored to account for indirect measurement and/or abandonment estimates, as well as direct measurement.

In another embodiment, the timing of the notification is determined, in part, by an estimation of when customer 104 and/or item 110 will place portion 102 in the less than ideal state. For example, if item 110 is a heavy item requiring additional staff 124 to lift in order for customer 104 to complete the purchase of item 110, knowing when the additional staff 124 is needed may be determined by estimating historical behavior of prior customers 104 and/or by direct measurement of customer 104 having selected item 110. Continuing the example, customer 104 may have selected item 110, a heavy item, from a distant location in portion 102, whereby customer 104 may take a minimum of several minutes to enqueue for checkout to complete the purchase of item 110. As several minutes will be required for the purchase of item 110 to impact portion 102, if such an impact would place retail setting in a less than ideal state, server 118 may either delay notification of staff member(s) 124 or notify staff member(s) 124 with a message that their services will be required at a future time. The location of the additional staff member(s) 124 may also be considered. For example, if the additional staff member(s) 124 are stationed fifteen seconds away then they can be notified much later than if they are in a different building several minutes away.

The allocation of staff members 124 is variously embodied. Staff members 124 may have one or more skills or attributes that may determine which one or more staff members 124 is selected for a particular purpose and/or excluded for another purpose. In another example, when item 110 is determined to be, or about to be, purchased and cashiering staff is determined to be below a threshold value, staff member 124A is notified. However, if staff members 124 is currently unavailable (e.g., helping another customer) or has attributes (e.g., knowledge of a certain product, ability to lift heavy items, language skills, etc.) that are currently in demand, then they may be excluded from notification. For example, staff member 124C is fluent in German and currently engaged with customer 104 who is only conversational in German. Therefore, staff member 124C, who may also be an expert in a certain product line may be omitted for selection in favor of another staff member, even with less expertise in the certain product line, if assisting customer 104 would be interrupted. In contrast if more than one staff members 124 are fluent in German, then staff member 124C may be notified to help with a heavy item selected by another customer and staff member 124A notified to relieve staff member 124 and assist the German-speaking customer.

In another embodiment, sever 118 may determine that portion 102 is over allocated with staff members 124 and assign, via their respective devices 122 and/or devices 122 of their management, to perform other duties (e.g., “Inventory stockroom shelf #10,” “Begin placing signage for tomorrow's sale,” “Stop cashiering and report to your manager,” etc.).

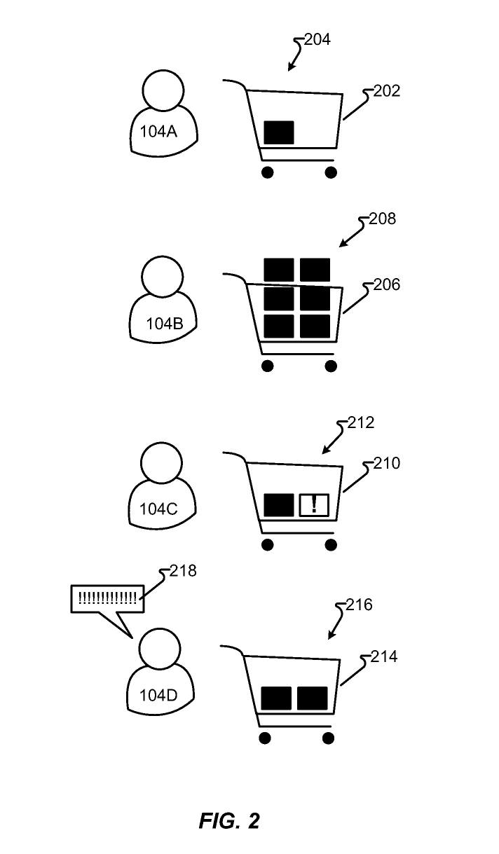

With reference now to FIG. 2, customers 104 purchasing items will be described in accordance with embodiments of the present disclosure. FIG. 2 illustrates several embodiments of events detected by sensing devices 106 and processed by server 118, whereby the state of portion 102 may be determined to be in a non-ideal state and staff members 124 reallocated to mitigate the non-ideal state.

In one embodiment, customer 104A has selected item 204 for purchase, such as by picking up item 204 and placing item 204 into shopping cart 202. Customer 104A and/or item 204 may have no special attributes known or suspected. However, the volume of activity in portion 102 and/or retail setting 120 may cause the presence of customer 104A and/or item 204 may be determined by server 118 as placing portion 102 and/or retail setting 120 into a less than ideal state. Accordingly, staff member(s) 124 are notified to respond and place, or mitigate the deviation from, portion 102 and/or retail setting 120 in the more ideal state.

In another embodiment, customer 104B has selected a large volume of items 208, such as by placing them in cart 206. The determination of the volume may be provided by optical analysis of a signal from camera 106C, data from pressure mat 106B, a plurality of signals from a number of RFID tags 106D, and/or other sensing means. Accordingly, server 118 may determine that portion 102 and/or retail setting 120 may be placed in a less than ideal state, such as by the time required to process the purchase of each of items 208, and possibly other items associated with other customers, representing an unacceptably long delay to customer 104B and/or other customers. Accordingly staff member(s) 124 may be notified to respond accordingly.

In another embodiment, customer 104C has selected items 212 which require special handling. Special handling may include one or more of legal requirements (e.g., verify the age of customer 104B for the purchase of alcohol), additional step (e.g., retrieve an actual item, such as when items 212 include an indicia of a pseudoephedrine product and the product itself must be retrieved by staff member 124, complete product registration/warranty information, etc.), authority (e.g., manager's approval is required), special handling (e.g., heavy, fragile, special packaging, etc.), or other activity that may cause portion 102 and/or retail setting 120 to be in less than an ideal state.

In another embodiment, customer 104D has selected items 216 for purchase by placing them into cart 214. Customer 104D may have been explicitly identified, or otherwise known, to have attribute 218. Attribute 218 may represent an atypical demand on staff resources and cause server 118 to allocate/de-allocate staff members 124 accordingly. For example, customer 104D may have been previously identified via radio signal from a personal device (e.g., smartphone, Bluetooth enabled device, etc.) and, such as by receiver 114 detecting the same radio signal, identified as talkative or otherwise requiring additional attention from staff. Accordingly, server 118 may allocate additional staff 124, staff with a special attribute (e.g., fluent in American Sign Language), and/or a specific staff member (e.g., 124A who may have assisted customer 104D during their previous visit to portion 102) to assist customer 104D.

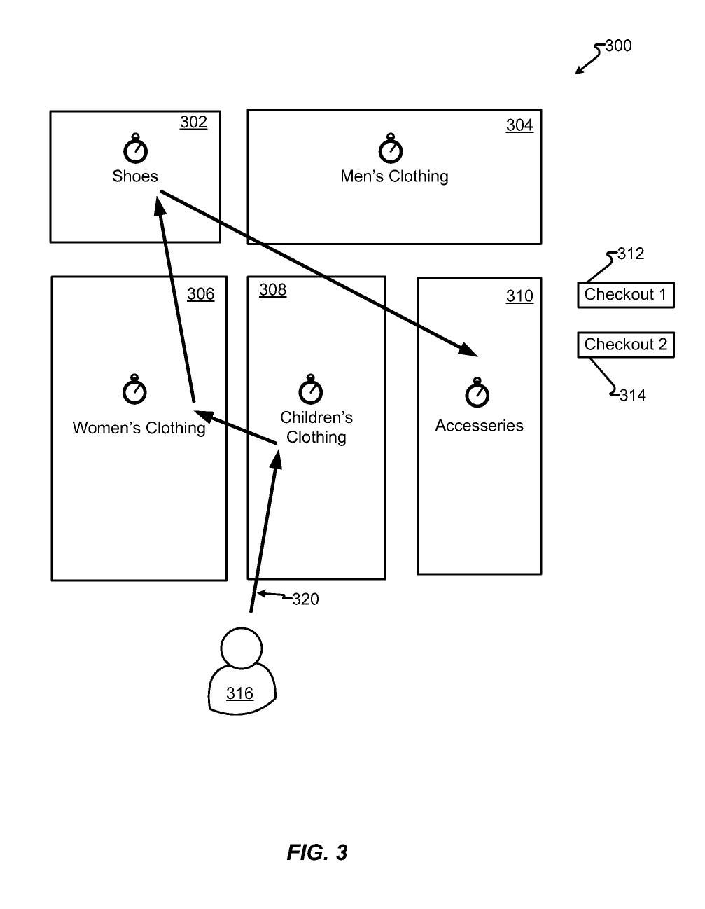

With reference now to FIG. 3, retail setting 300 will be described in accordance with embodiments of the present disclosure. Retail setting 300 comprises portions 302, 304, 306, 308, 310 and checkout 312, 314. Customer 316 is monitored, such as by systems and methods described with respect to FIG. 1, and determined to have traversed the various portions of retail setting 300, represented by path 320.

In one embodiment, customer 316 is determined to have spent a length of time in each of five portions 302, 304, 306, 308, 310, which may include a zero, or effectively zero, length of time, as illustrated with respect to portion 304. Having a zero, or effectively zero, length of time may be indicative of customer 316 passing through or next to portion 304 at a rate generally known to indicate traversal of the portion with little to no interaction with any items therein.

In one embodiment, the length of time customer 316 spends in ones of portions 308, 306, 302, and 310 may be indicative of items, or categories of items, customer 316 intends to purchase. For example, historical records may indicate that past customers who starts in children's clothing (portion 308) and moves to women's clothing (portion 306), will have selected four items for purchase. In another example, historical records may indicate that past customers who spend fifteen to twenty minute in children's clothing (portion 308) select three items for purchase and past customers who spend two or more hours in women's clothing (portion 306) select one item that requires custom tailoring. Accordingly, customer 316, following path 320, alone or in combination with other customers (not shown) may indicate an increase in demand for checkout services beyond the previously determined acceptable capacity of checkout 1 (312) operating alone and, accordingly, would place retail setting 300 in a less than ideal state. Upon determining that customer 316 being known, or estimated, to have selected a quantity of items that place retail setting 300 in a less than ideal setting, a processor, such as one running on server 118, may cause one or more of staff members 124 to be allocated to open and/or maintain checkout 2 (314). Similarly, staff members 124 associated with tailoring may be notified to report to portion 306, as customer 316 is likely to require tailoring services that are unavailable and/or over allocated, and by doing so, prevent portion 306 from entering a less than ideal state or placing it in a more ideal state if it has already departed therefrom.

In another embodiment, upon customer 316 completing the purchase of their selected items, retail setting 300 may again be in a less than ideal state, such as when the demand for cashiers to operate checkouts 1 and 2 (312, 314) drops to the point whereby closing one of checkouts 1 or 2 (312, 314) will be a more ideal state, such as one were staff members 124 are allocated to tasks other than operating checkouts.

In another embodiment, additional customer services may be provided to anticipate the needs of customer 316. Path 320 takes customer 316 through children's clothing (portion 308), women's clothing (portion 306), and shoes (portion 302). Based on historical records and/or specific items selected by customer 316, it may be determined that customer 316 is selecting a complete wardrobe for a formal event. Upon customer entering or approaching accessories (portion 310) a staff member 124 may be notified who can help select items that complement items selected in other portions (e.g., 306, 302). In another embodiment, a staff member 124 may be notified that customer 320 may have children, as predicted by time spent in children's clothing (portion 308) and/or inputs from sensing devices 106. Staff member(s) 124 may be notified accordingly and, for example, meet customer 316 in accessories (portion 310) with a shopping cart to accommodate items known or suspected to be carried by customer 316 and/or items to curry favor with children (e.g., toys, snacks, etc.). In another embodiment, customer 316 may be known or suspected of selecting a high-value item from a prior portion (e.g., 308, 306, 302). Accordingly, staff member(s) 124 having expertise and/or authority to sell upscale accessories may be notified such that they may meet customer 316 in the accessories (portion 310) with the ability to provide the services likely desired by customer 316.

In another embodiment, customer 316 may spend an amount of time in portion 302 that is generally associated with someone looking for a particular item. Furthermore, sensing devices 106 may determine that customer 316 did not select any item within portion 302. Customer 320 may then move to portion 310 whereby automatically or at the request of customer 316, at least one of staff members 124 is requested to assist customer 316. The specific staff member 124 that is selected may be determined based on expertise in portion 302—from where customer 316 did not select an item. As a benefit, a customer who appears not to find an acceptable item in a first portion, and then goes to a second portion, may be assisted with someone with expertise in the first portion. For example, a customer who has spent a significant amount of time in a plumbing section, but has not selected an item, and moves to the electrical section, may be assisted by a staff member with plumbing expertise. As a benefit, the customer may be assisted in locating a sought after plumbing item.

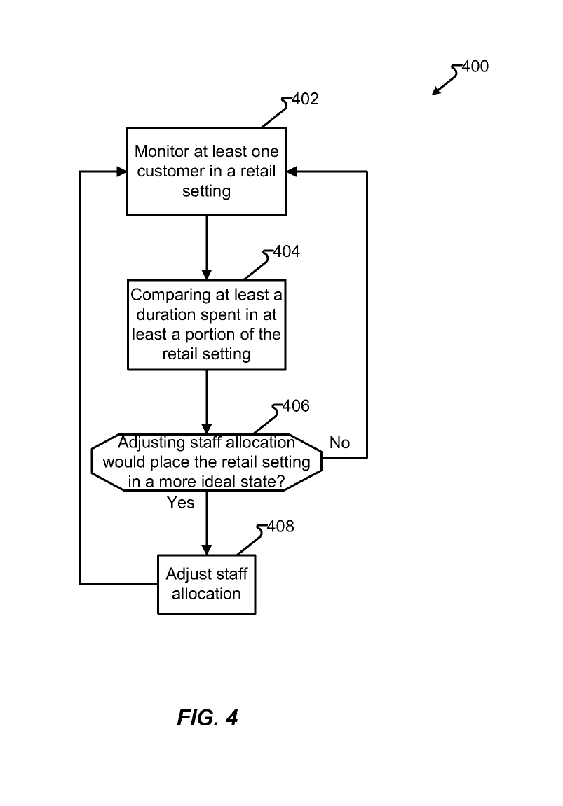

With reference now to FIG. 4, process 400 will be described in accordance with embodiments of the present disclosure. In one embodiment, step 402 monitors at least one customer in a retail setting. Step 404 determines, such as be sensing devices 106 in communication with server 118, at least the length of time one or more customers spends in at least a portion of the retail setting.

Step 406 then determines if, based on comparing step 404, a staffing allocation adjustment should be made to place the retail setting in a more ideal state. If no, processing may continue back to step 402. If yes, processing continues to step 408 whereby staffing allocation adjustments are implemented, such as by notifying at least one of staff members 124 via device 122. Processing may then return to step 402.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method, comprising:
monitoring, by machine-based detection equipment, a retail setting and one or more customers therein;
comparing, by a microprocessor, an activity comprising at least a duration of time spent by the one or more customers within a first portion of the retail setting to a current staff allocation; and
based on the comparison step, determining that adjusting the current staff allocation would place the retail setting in a more ideal state, notifying a resource allocation manager to apply a staffing allocation adjustment.

2. The method of claim 1, wherein the activity further comprises, one or more customers moving to a second portion of the retail setting.

3. The method of claim 1, wherein the activity further comprises, selecting an item for purchase from the first portion of the retail setting.

4. The method of claim 1, wherein the step of monitoring further comprises, monitoring the radio frequency identification signal of an item for sale in the retail setting.

5. The method of claim 4, wherein the step of monitoring further comprises, monitoring the radio frequency identification signal of a collection of items for sale including the item.

6. The method of claim 1, further comprising:
accessing a staffing database having a number of staff records each staff record comprising at least an entry for availability and a number of staff attributes; and
the comparison step further comprises comparing the availability and number of staff attributes of staff to the staffing allocation adjustment.

7. The method of claim 6, further comprising:
accessing a staff attribute associated with an item; and
the comparison step, further determining that adjusting the current staff allocation would place the retail setting in the more ideal state, comprising at least providing the staff attribute associated with the item and notifying a resource allocation manager to apply a staffing allocation adjustment.

8. The method of claim 6, wherein:
the step of monitoring, further comprises, monitoring at least one customer attribute of at least one of the one or more customers; and
the comparison step, further determining that adjusting the current staff allocation would place the retail setting in the more ideal state, comprising at least providing the staff attribute beneficial to assist the one or more customers and notifying a resource allocation manager to apply a staffing allocation adjustment.

9. The method of claim 8, wherein monitoring at least one customer attribute, further comprises, determining the identity of one or more customers and wherein the staff attribute is a prior interaction attribute associated with one or more staff members and the one or more customers.

10. A system, comprising:
a first sensor;
a microprocessor; and
a staffing allocation manager; and
wherein the first sensor is operable to monitor a first portion of a retail setting and one or more customers therein;
wherein the microprocessor is operable to compare an activity comprising at least a duration of time spent by the one or more customers within the first portion of the retail setting to a current staff allocation; and
wherein the processor, based on the comparison step, determining that adjusting the current staff allocation would place the retail setting in a more ideal state, notifying the resource allocation manager to apply a staffing allocation adjustment.

11. The system of claim 10, further comprising:
a second sensor; and
wherein the activity further comprises, the second sensor detecting the one or more customers have moved to a second portion of the retail setting.

12. The system of claim 10, wherein the first sensor is a radio frequency identification receiver operable to receive a radio frequency identification signal of an item for sale.

13. The system of claim 10, further comprising:
a staffing database, comprising a number of staff records comprising at least an entry for availability and a number of staff attributes; and
the processor is operable to perform the comparison, further comprising, comparing the availability and the number of staff attributes to the staffing allocation adjustment.

14. A non-transitory computer readable medium with instructions thereon, that when read by a computer, cause the computer to perform:
monitoring, by machine-based detection equipment, a retail setting and one or more customers therein;
comparing, by a microprocessor, an activity comprising at least a duration of time spent by the one or more customers within a first portion of the retail setting to a current staff allocation; and
based on the comparison step, determining that adjusting the current staff allocation would place the retail setting in a more ideal state, notifying a resource allocation manager to apply a staffing allocation adjustment.

15. The medium of claim 14, wherein the activity further comprises, one or more customers moving to a second portion of the retail setting.

16. The medium of claim 14, wherein the activity further comprises, instructions for selecting an item for purchase from the first portion of the retail setting.

17. The medium of claim 14, further comprising instructions to:
access a staffing database having a number of staff records each staff record comprising at least an entry for availability and a number of staff attributes; and
the instructions for the comparison step further comprises instructions for comparing the availability and number of staff attributes of staff to the staffing allocation adjustment.

18. The medium of claim 17, further comprising:
instructions for accessing a staff attribute associated with an item; and
the instructions for comparison, further comprise instructions for determining that adjusting the current staff allocation would place the retail setting in the more ideal state, comprising at least providing the staff attribute associated with the item, and instructions for notifying a resource allocation manager to apply a staffing allocation adjustment.

19. The medium of claim 17, wherein:
the instructions for monitoring, further comprise instructions for monitoring at least one customer attribute of at least one of the one or more customers; and
the instructions for the comparison step, further comprise instructions for determining that adjusting the current staff allocation would place the retail setting in the more ideal state, comprising at least providing the staff attribute beneficial to assist the one or more customers, and instructions for notifying a resource allocation manager to apply a staffing allocation adjustment.

20. The medium of claim 20, wherein the instructions for monitoring at least one customer attribute, further comprise, instructions for determining the identity of one or more customers and wherein the staff attribute is a prior interaction attribute associated with one or more staff members and the one or more customers.
